(19) United States
(12) Patent Application Publication
(10) Pub. No.: US 2017/0173796 A1
(43) Pub. Date: Jun. 22, 2017

(54) TRANSFER ROBOT AND CONTROL METHOD THEREOF

(71) Applicant: Samsung Electronics Co., Ltd., Suwon-si (KR)

(72) Inventors: Kwang-Jun Kim, Ansan-si (KR); Doojin Kim, Hwaseong-si (KR); Kongwoo Lee, Seoul (KR); Joohyung Kim, Seongnam-si (KR); Kyungbin Park, Suwon-si (KR); Nam-Su Yuk, Suwon-si (KR)

(21) Appl. No.: 15/278,402

(22) Filed: Sep. 28, 2016

(30) Foreign Application Priority Data
Dec. 18, 2015 (KR) 10-2015-0181879

(51) Int. Cl. B25J 9/16; B65G 47/90; G05D 1/02

(52) U.S. Cl. CPC B25J 9/1697; G05D 1/0246; B65G 47/905; B25J 9/1679; Y10S 901/01; G05B 2219/40053

(57) ABSTRACT

The present disclosure relates to a transfer robot and a method for controlling the same. The transfer robot includes a robot main body and a driving unit configured to move the robot main body toward a stage. The robot main body includes a distance sensor unit configured to obtain distance information between the robot main body and the stage, a first image acquisition unit configured to receive an image of a first mark of the stage and obtain a first image information, a manipulation unit configured to pick up a target object disposed on the stage, and a control unit configured to control the driving unit using the distance information and the first image information and thereby to causing the robot main body to be placed at a desired position spaced apart from the stage.

### CROSS-REFERENCE TO RELATED APPLICATIONS

This U.S. non-provisional patent application claims priority under 35 U.S.C. §119 to Korean Patent Application No. 10-2015-0181879, filed on Dec. 18, 2015, in the Korean Intellectual Property Office, the entire contents of which are hereby incorporated by reference.

### FIELD

The present disclosure relates generally to robotics, and more specifically to a transfer robot and a method of controlling the same.

### BACKGROUND

Transfer robots are widely used in various industrial fields. For example, in the semiconductor industry, a transfer robot is used to transfer a substrate (e.g., a semiconductor wafer, a liquid crystal display panel, or a unit disk of a disk drive). One or more substrates are disposed in a container (e.g., a cassette) and then are delivered to each work area in a fabrication line using the transfer robot.

A conventional transfer robot is configured to move to a stage, on which a target object is disposed, along a moving rail. In other words, the conventional transfer robot is allowed to move along a fixed path. However, to improve efficiency in production or space utilization, the stage may be relocated or an obstacle may block the fixed path thus requiring the robot to take a different path. In this case, to make it possible for the transfer robot to transfer the target object, it is necessary to either rebuild the moving rail or remove the obstacle from the fixed path, either of which reduces transfer efficiency. To avoid such issues, it is necessary to develop a transfer robot capable of moving to the stage in an autonomous manner and picking up the target object on the stage.

### SUMMARY

Some embodiments of the inventive concept include a transfer robot, which is configured to move to a desired position in an autonomous manner and to grasp and pick up a target object, and a method of controlling the same.

According to some embodiments of the inventive concept, a transfer robot may include a robot main body and a driving unit configured to move the robot main body toward a stage. The robot main body may include a distance sensor unit configured to obtain distance information between the robot main body and the stage, a first image acquisition unit configured to take an image of a first mark of the stage and to obtain a first image information, a manipulation unit configured to pick up a target object disposed on the stage, and a control unit configured to control the driving unit using the distance information and the first image information and thereby to cause the robot main body to be placed at a desired position spaced apart from the stage.

According to some embodiments of the inventive concept, a transfer robot may include a robot main body equipped with a driving unit, which is used to move the robot main body toward a stage in an autonomous manner; a first image acquisition unit configured to take an image of a three-dimensional first mark of the stage and to obtain first image information; a manipulation unit provided on the robot main body to pick up a target object disposed on the stage; and a control unit configured to obtain a projection area of the first mark on an X-Z plane, a length in a Y-direction of the first mark, and X- and Z-coordinates of a reference point of the first mark from the first image information, to calculate a distance between the robot main body and the stage based on the projection area of the first mark on the X-Z plane, and to calculate a relative angle between the robot main body and the stage from the length in the Y-direction of the first mark. The relative angle, the distance, and the X- and Z-coordinates may be used to place the robot main body at a desired position that is appropriately spaced apart from the stage, under the control of the driving unit.

According to some embodiments of the inventive concept, a method of controlling a transfer robot may include moving a robot hand, which includes a plurality of fingers configured to grasp a target object having grip recesses, to a first position using a robot arm, partially inserting the fingers into the grip recesses, with the robot hand at the first position, elevating the robot hand to a second position higher than the first position, using the robot arm, and further inserting the fingers into the grip recesses with the robot hand at the second position.

According to some embodiments of the inventive concept, a transfer robot comprises a steerable platform having an articulating arm attached thereto. A controller is coupled to the steerable platform. The controller is configured to position a first surface of the steerable platform at a predetermined distance, and with parallel alignment, to a second surface of a stage having a target object disposed thereon. A robotic hand is connected to the articulating arm. The robotic hand includes at least two movable phalanxes configured to grip a respective recessed feature of the target object.

In some embodiments, the transfer robot further comprises an obstacle sensor proximally located to the first surface. The obstacle sensor is configured to detect an object between the steerable platform and the stage, and to communicate to the controller to alter a path between the steerable platform and the stage.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view illustrating a transfer robot according to some embodiments of the inventive concept.

FIG. 2 is a plan view illustrating the transfer robot of FIG. 1.

FIG. 3 is a block diagram of an example embodiment of the transfer robot of FIG. 1.

FIG. 4 is a flow chart of a process for moving the transfer robot of FIG. 1 toward a stage according to an embodiment of the present disclosure.

FIG. 5 and FIG. 6 are plan views illustrating a movement of the transfer robot of FIG. 1 toward a stage along a driving path in an autonomous manner.

FIG. 7 and FIG. 8 are plan views illustrating a positioning of a robot main body relative to a stage, based on distance information and first image information that are obtained by the distance sensor unit and the first image acquisition unit, respectively of FIG. 1.

FIG. 9 is a schematic view of an example of the first image information obtained by the first image acquisition unit in the state of FIG. 7.

FIG. 10 is a schematic view of an example of the first image information obtained by the first image acquisition unit in the state of FIG. 8.

FIG. 11 is a flow chart of a process for grasping and picking up a target object using the transfer robot of FIG. 1.

FIG. 12 and FIG. 13 are diagrams schematically illustrating a process for scanning a target object using the target object-sensing unit of FIG. 1.

FIG. 14 and FIG. 15 are diagrams schematically illustrating a process for controlling positions of fingers of a robot hand relative to respective grip recesses of a target object, using second image information obtained by the second image acquisition unit of FIG. 1.

FIG. 16, FIG. 17, and FIG. 18 are diagrams schematically illustrating a process for grasping and picking up a target object using the robot hand of FIG. 1.

FIG. 19 is diagrams schematically illustrating a process for scanning a target object using a target object-sensing unit of a transfer robot according to some embodiments of the inventive concept.

FIG. 20 is a perspective view illustrating a transfer robot according to some embodiments of the inventive concept.

FIG. 21 is a plan view illustrating the transfer robot of FIG. 20.

FIG. 22 is a block diagram of an example embodiment of the transfer robot of FIG. 20.

FIG. 23 and FIG. 24 are plan views of a process for controlling a position of a robot main body relative to a stage using first image information obtained by the first image acquisition unit of FIG. 20.

FIG. 25 is a schematic view of an example of the first image information obtained by the first image acquisition unit in the state of FIG. 23.

FIG. 26 is a schematic view of an example of the first image information obtained by the first image acquisition unit in the state of FIG. 24.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

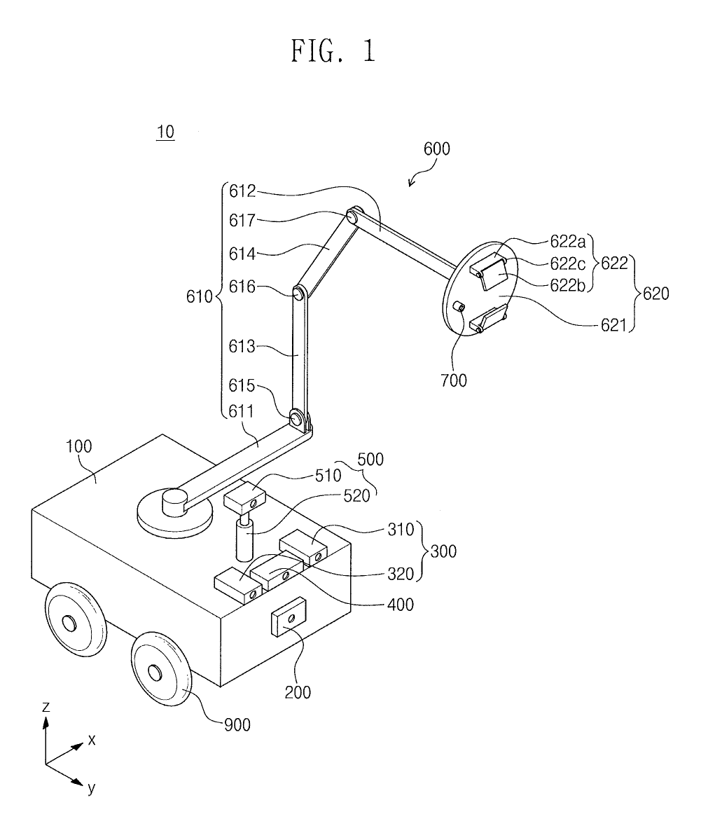

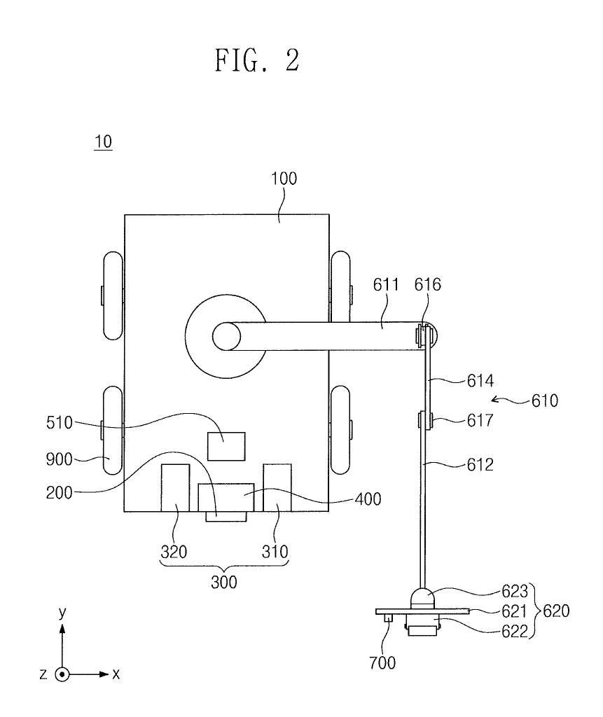

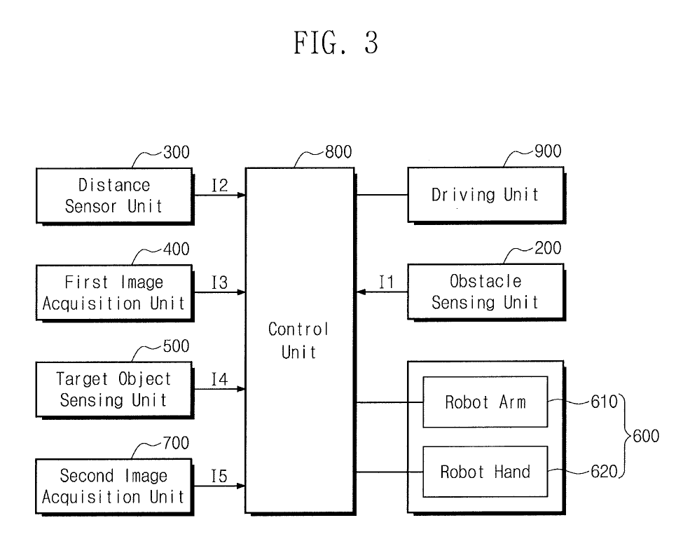

FIG. 1 is a perspective view illustrating a transfer robot according to some embodiments of the inventive concept. FIG. 2 is a plan view illustrating a transfer robot of FIG. 1. FIG. 3 is a block diagram of an example embodiment of configuration of a transfer robot of FIG. 1.

Referring to FIG. 1, FIG. 2, and FIG. 3, a transfer robot 10 according to some embodiments of the inventive concept may include a robot main body comprising units 100 to 800 (hereinafter “100-800”), and a driving unit 900.

The robot main body 100-800 may include a body unit 100, a control unit 800, a distance sensor unit 300, a first image acquisition unit 400, and a manipulation unit 600. The transfer robot 10 may further include a target object-sensing unit 500, a second image acquisition unit 700, and an obstacle-sensing unit 200.

At least a part of the appearance of the transfer robot 10 may be defined by the body unit 100. The body unit 100 may be equipped with various units. For example, the body unit 100 may be equipped with the obstacle-sensing unit 200, the distance sensor unit 300, the first image acquisition unit 400, the target object-sensing unit 500, the manipulation unit 600, the control unit 800, and the driving unit 900. In various embodiments, the control unit 800 of FIG. 3 is inside, or a surface of, the body unit 100 although placement of the control unit 800 is not limited thereto.

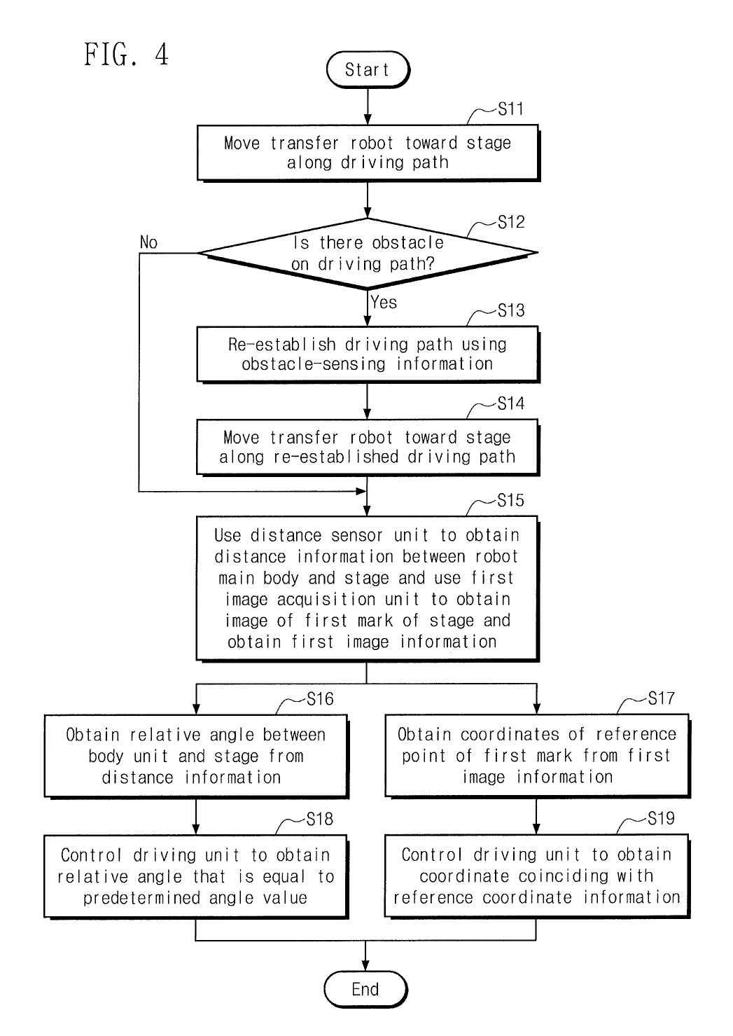

The obstacle-sensing unit 200 may be oriented to a driving direction of the robot main body 100-800. Accordingly, the obstacle-sensing unit 200 may be configured to detect an obstacle “O” (such as an object, a human, or a stage) (e.g., see FIG. 4), which may be located along the driving direction of the robot main body 100-800. The obstacle-sensing unit 200 may include one or more of an ultrasonic wave sensor, a laser sensor, and an infrared light sensor. However, the inventive concept may not be limited thereto. For example, various sensors may be used for the obstacle-sensing unit 200, if they are capable of detecting the obstacle O located along the driving direction of the robot main body 100-800. In various embodiments, a combination of sensors types are used to optimize both short range and long range detection, or to improve the reliability of the detection under various lighting and environmental conditions. In some embodiments, the obstacle-sensing unit 200 may include a laser sensor. For example, the obstacle-sensing unit 200 may include a 2D laser scanner or a laser range finder, which is configured to measure a horizontal distance to an object (e.g., the obstacle O). The laser sensor may be configured to emit a laser beam in the driving direction of the body unit 100, to receive the laser beam reflected by the obstacle O, and to obtain information (hereinafter, obstacle-sensing information “I1”) regarding the presence or absence of the obstacle O or position of the obstacle O. The obstacle-sensing information I1 obtained by the obstacle-sensing unit 200 may be transmitted to the control unit 800. The obstacle-sensing information I1 may contain information on a distance between the body unit 100 and the obstacle O, a position of the obstacle O, or both the distance and the position. The position information of the obstacle O may include X- and Y-coordinates of the obstacle O relative to the body unit 100. In one example, the X and Y coordinates are derived from X and Y axes, which are orthogonal to each other, and parallel to a surface upon which the transfer robot moves, (see FIG. 1).

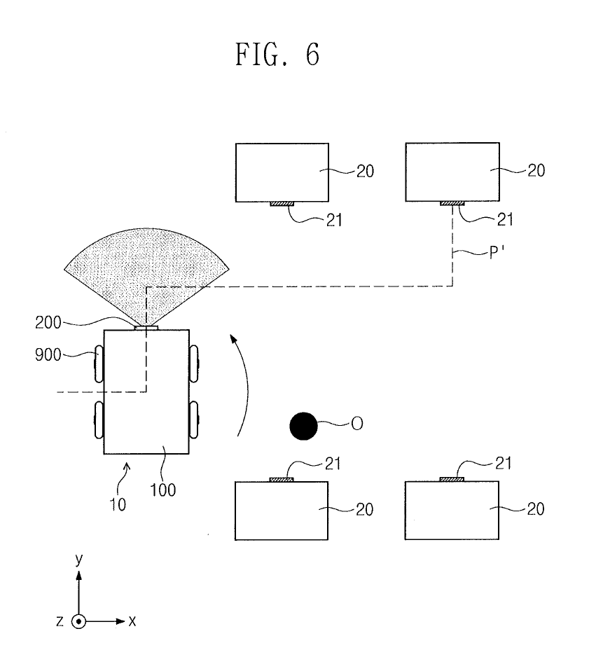

The distance sensor unit 300 may be configured to obtain information (hereinafter, distance information “I2”) pertaining to a distance between the robot main body 100-800 and a stage 20, (e.g., see FIG. 6). In some embodiments, the distance information I2 may contain information pertaining to a distance from the front of the body unit 100 of the robot main body 100-800 to the stage 20, wherein the front is defined by the location of the distance sensor. The distance sensor unit 300 may be provided on a top surface of the body unit 100. The distance sensor unit 300 may include a first distance sensor 310 and a second distance sensor 320. The first distance sensor 310 and the second distance sensor 320 may be symmetrically arranged about the first image acquisition unit 400. the first distance sensor 310 and the second distance sensor 320 are equidistant from the first image acquisition unit 400. The first distance sensor 310 and the second distance sensor 320 may include one or more of an ultrasonic wave sensor, a laser sensor, and an infrared light sensor, but the inventive concept may not be limited thereto. For example, various sensors may be used for the first and second distance sensors 310 and 320, if they are capable of measuring the distance to an object, (e.g., the stage 20).

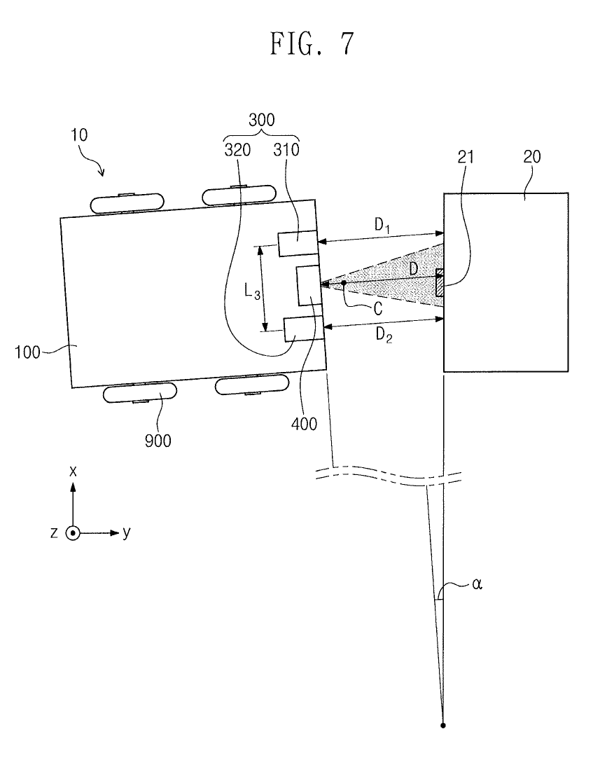

As shown in FIG. 7, the stage 20 may be provided to have a first mark 21, and the first image acquisition unit 400 may be configured to obtain first image information (hereinafter “I3”), in which images of the first mark 21 are contained. The first image information I3 may be transmitted from the first image acquisition unit 400 to the control unit 800.

The first image acquisition unit 400 may be provided on the top surface of the body unit 100. The first image acquisition unit 400 may be disposed between the first distance sensor 310 and the second distance sensor 320. For example, the first image acquisition unit 400 may be positioned to be equidistant from the first and second distance sensors 310 and 320. The first image acquisition unit 400 may be placed on a Y-Z plane, (wherein the Z axis is orthogonal to both the X and Y axes), passing through a center of the body unit 100. Here, the center of the body unit 100 may be the center of gravity of the body unit 100. The first image acquisition unit 400 may include a charge-coupled device (CCD), but the inventive concept may not be limited thereto. For example, various imaging units may be used for the first image acquisition unit 400, if they have an imaging function.

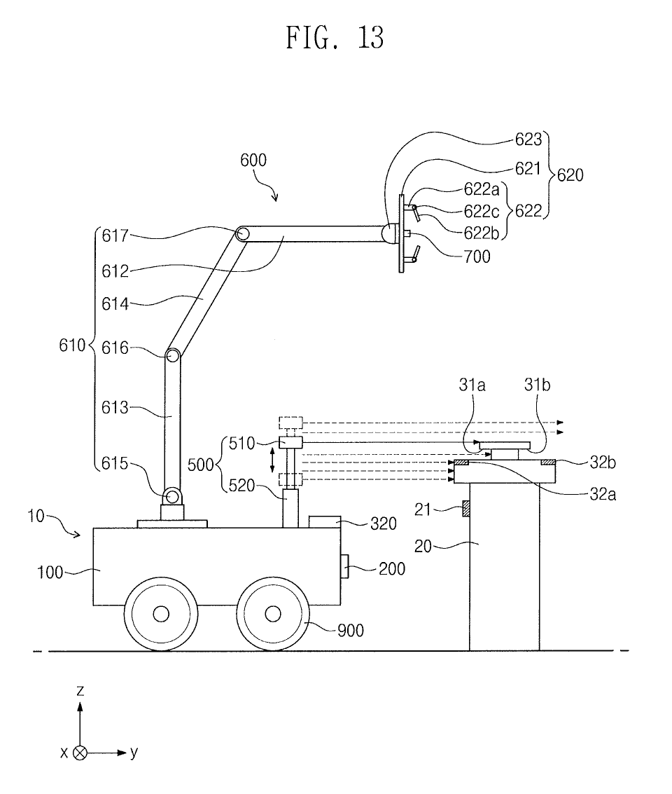

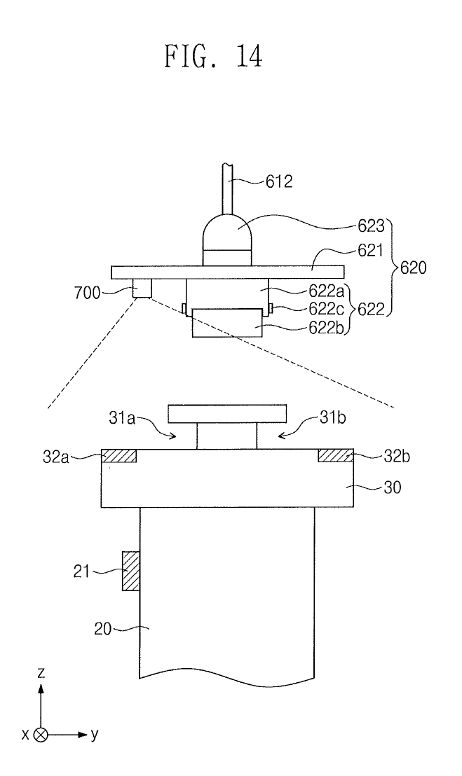

The manipulation unit 600 may be configured to grasp and pick up a target object 30 (e.g., see FIG. 13 and FIG. 14), which is disposed on the stage 20. In some embodiments, the manipulation unit 600 may be provided on the body unit 100. The manipulation unit 600 may include a robot hand 620, which is configured to grasp the target object 30 (e.g., see FIG. 13 and FIG. 14), and a robot arm 610, (which is connected to the robot hand 620), and is used to change a position of the robot hand 620. In some embodiments, the robot hand 620 may be coupled to a portion of the robot arm 610.

The robot arm 610 may include a plurality of rods 611-614 and at least one hinge 615-617. Alternatively, the robot arm 610 may be provided in the form of a single rod. In some embodiments, the robot arm 610 may include a first rod 611, a second rod 612, a third rod 613, a fourth rod 614, a first hinge 615, a second hinge 616, and a third hinge 617. At least one or all of the first, second, third, and fourth rods 611-614 may be shaped like an elongated bar with a circular or rectangular section, but the inventive concept may not be limited thereto.

The first rod 611 may include an end portion, which is connected to the body unit 100. The first rod 611 may be placed on an X-Y plane, as shown in FIG. 1. The first rod 611 may be configured to rotate about its end portion around the Z plane, which is connected to the body unit 100, on the X-Y plane. The third rod 613 may include an end portion, which is connected to an opposite end portion of the first rod 611. The third rod 613 may be placed on a plane normal to the first rod 611. The third rod 613 may be configured to rotate about its end portion, which is connected to the first rod 611, on a plane normal to the first rod 611. The fourth rod 614 may include an end portion, which is connected to an opposite end portion of the third rod 613. The fourth rod 614 may be placed on a plane normal to the first rod 611. The fourth rod 614 may be configured to rotate about its end portion, which is connected to the third rod 613, on a plane normal to the first rod 611. The second rod 612 may include an end portion, which is connected to the robot hand 620. The second rod 612 may include an opposite end portion, which is connected to an opposite end portion of the fourth rod 614. The second rod 612 may be placed on a plane normal to the first rod 611. The second rod 612 may be configured to rotate about its opposite end portion, which is connected to the fourth rod 614, on a plane normal to the first rod 611.

The first hinge 615 may connect the first rod 611 to the third rod 613 to allow the third rod 613 to be rotatable about the first rod 611. The second hinge 616 may connect the third rod 613 to the fourth rod 614 to allow the fourth rod 614 to be rotatable about the third rod 613. The third hinge 617 may connect the second rod 612 to the fourth rod 614 to allow the second rod 612 to be rotatable about the fourth rod 614.

As described above, the robot hand 620 may be connected to an end portion of the robot arm 610, (e.g., to the second rod 612 for the embodiment shown in FIG. 1). The use of the robot arm 610 may allow the robot hand 620 to have at least one degree of freedom. In other words, the use of the robot hand 620 may make it possible to enlarge a range of a workspace spanned by the robot arm 610. Here, the degree of freedom of the robot hand 620 is the number of coordinates of the robot hand 620 that may vary independently.

The robot hand 620 may include a palm 621, plurality of fingers 622, and a palm-rotating unit 623. The palm 621 may be a flat plate with a specific area. The palm 621 may be a circular or rectangular disk with a flat surface. The palm-rotating unit 623 may be connected to a surface of the palm 621. The palm-rotating unit 623 may be configured to rotate the palm 621. In certain embodiments, the palm 621 may be configured to be rotated by the robot arm 610. For example, the second rod 612 may be configured to rotate about a rotation axis passing through its two opposite end portions. Such a rotation of the second rod 612 may lead to rotation of the palm 621. The fingers 622 may be connected to an opposite surface of the palm 621, opposing a surface connected to the palm-rotating unit 623. In addition, the second image acquisition unit 700 may be provided on the opposite surface of the palm 621. In one example, the second image acquisition unit 700 is one the same surface of the palm 621 as the fingers 622.

Each of the fingers 622 may be inserted into a corresponding one of a plurality of grip recesses 31a and 31b (e.g., see FIG. 14) of the target object 30. Each of the fingers 622 may include a plurality of phalanxes 622a and 622b and at least one first joint 622c. In some embodiments, the plurality of phalanxes may include a first phalanx 622a directly connected to the palm 621 and a second phalanx 622b serving as a terminal of each of the fingers 622. In certain embodiments, the plurality of phalanxes may include the first phalanx 622a directly connected to the palm 621, and the second phalanx 622b serving as the terminal of each of the fingers 622, in addition to at least one third phalanx (not shown) connecting the first phalanx 622a with the second phalanx 622b. The first phalanx 622a and the second phalanx 622b may be connected to each other by the first joint 622c. Accordingly, the second phalanx 622b may rotate about the first joint 622c.

The palm-rotating unit 623 may be connected to an end portion of the robot arm 610. As described above, the palm-rotating unit 623 may be connected to the surface of the palm 621. The palm-rotating unit 623 may be configured to rotate the palm 621. This may make it possible to change or control positions of the fingers 622.

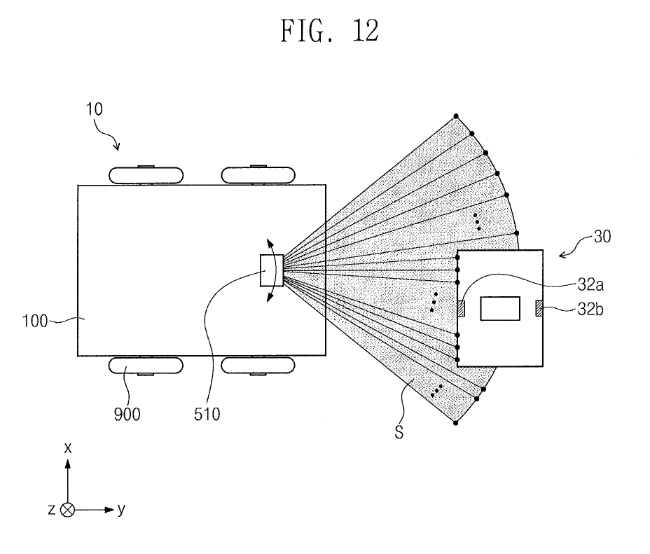

The target object-sensing unit 500 may be configured to detect the target object 30 provided on the stage 20. The target object-sensing unit 500 may include a detection sensor 510 and a scan unit 520. A position of the detection sensor 510 may be controlled by the scan unit 520, to enable the detection sensor 510 to detect the target object 30 in a scan region “S” (e.g., see FIG. 12). In one embodiment, the scan unit 520 is configured to rotate about the Z plane to form the scan region S of FIG. 12. In another embodiment, the scan unit 520 is further configured to rotate about the Z plane and to extend collinear with the Z plane, thereby scanning a two dimensional plane. The detection sensor 510 may include one or more of a laser sensor, an ultrasonic wave sensor, and an infrared light sensor, but the inventive concept may not be limited thereto. In some embodiments, the detection sensor 510 may include a 2D laser scanner or a laser range finder, which is configured to measure a horizontal distance to an object. Here, the scan region S may be a three-dimensionally region defined by X, Y, and Z-axes. The scan unit 520 may be configured to control a position of the detection sensor 510, and thus, it is possible for the detection sensor 510 to scan the target object 30 in the scan region S. The target object-sensing unit 500 may obtain target object position information “I4” on the target object 30 using the detection sensor 510. This will be described with reference to FIG. 12 and FIG. 13.

The target object 30 may have second marks 32a and 32b, (e.g., see FIG. 14), and the second image acquisition unit 700 may be configured to obtain second image information “I5”, in which images of the second marks 32a and 32b are contained. The second image information I5 may be transmitted from the second image acquisition unit 700 to the control unit 800, either through a wired or wireless connection. The second image acquisition unit 700 may include a charge-coupled device (CCD), but the inventive concept may not be limited thereto. For example, various imaging units may be used for the second image acquisition unit 700. In some embodiments, the second image acquisition unit 700 may be provided on the manipulation unit 600. However, in certain embodiments, the second image acquisition unit 700 may be provided on other units, (e.g., the body unit 100). For example, the second image acquisition unit 700 may be provided on the robot hand 620.

The control unit 800 may be provided in the body unit 100. Accordingly, the control unit 800 may be protected from an external impact. The control unit 800 may be configured to receive the obstacle-sensing information I1 from the obstacle-sensing unit 200. The control unit 800 may be configured to receive the distance information I2 from the distance sensor unit 300. The control unit 800 may be configured to receive the first image information I3 from the first image acquisition unit 400. The control unit 800 may be configured to receive the target object position information I4 from the target object-sensing unit 500. The control unit 800 may be configured to receive the second image information I5 from the second image acquisition unit 700. In the control unit 800, the received information I1-I5 may be used to control the driving unit 900 and the manipulation unit 600. The control unit 800 will be described in more detail with reference to FIG. 4 to FIG. 18.

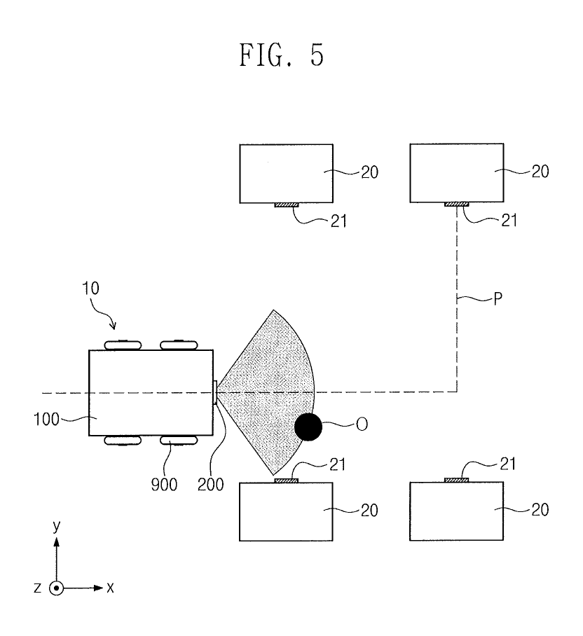

The robot main body 100-800 may be moved toward one of a plurality of stages 20 (e.g., see FIG. 5) by the driving unit 900. For example, when information on a target position “C”, (e.g., see FIG. 7) adjacent to the stage 20 is input by a user, the robot main body 100-800 may be moved to the target position C by the driving unit 900.

In some embodiments, the driving unit 900 may include a plurality of driving wheels (not shown), which are configured to control the motion of the robot main body 100-800, and a driving part (not shown), which is configured to apply a driving force to the driving wheels, but the inventive concept is not limited thereto. For example, various devices may be provided in the driving unit 900, if they are capable of moving the robot main body 100-800. The driving part may apply a driving force to the plurality of driving wheels, in response to control signals transmitted from the control unit 800. The driving force of the driving unit 900 may be used to move the robot main body 100-800 along the X-Y plane. In addition, the driving unit 900 may further include an apparatus for changing a position of the robot main body 100-800 in a Z-direction. In one embodiment, the driving unit includes four wheels. In other embodiments, the driving unit includes three wheels to ensure that all wheels remain in contact with the floor. In other embodiments, the driving unit includes low wear components that are suitable for a clean room environment.

FIG. 4 is a flow of a process for moving the transfer robot of FIG. 1 toward a stage. FIG. 5 and FIG. 6 are plan views illustrating a movement of the transfer robot of FIG. 1 toward a stage along a driving path in an autonomous manner.

Referring to FIG. 1 to FIG. 6, the control unit 800 may optimize a driving path “P” of the transfer robot 10, based on information on a position of a particular stage 20 from one or more stages (hereinafter, “position information” of the stage 20), which may be previously prepared using, for example, a mapping method. For example, in the control unit 800, an optimized or shortest distance between the robot main body 100-800 and the stage 20 may be obtained from the position information of the stage 20, and the driving path P corresponding to the obtained shortest distance may be established. In certain embodiments, the driving path P may be input via a user interface (not shown) by a user. Here, the position information of the stage 20 may include X- and Y-coordinates of the stage 20. The driving unit 900 may be controlled by the control unit 800 to allow the robot main body 100-800 to move toward the stage 20 along the established driving path P. In other words, the transfer robot 10 may move toward the stage 20 along the driving path P (in step S11 of FIG. 4). Accordingly, the robot main body 100-800 may move to the target position C (e.g., see FIG. 7) adjacent to the stage 20 by the driving unit 900.

With reference to FIG. 5, when an obstacle O is placed on the driving path P, the obstacle-sensing unit 200 may be used to detect the presence of the obstacle O, which is placed on the driving direction of the robot main body 100-800 (in step S12 of FIG. 4). The control unit 800 may be configured to receive the obstacle-sensing information I1 from the obstacle-sensing unit 200. As shown in FIG. 6, the control unit 800 may re-establish a driving path P′ using the obstacle-sensing information I1 (in step S13 of FIG. 4). For example, the control unit 800 may obtain position information on X- and Y-coordinates of an obstacle, based on the obstacle-sensing information I1. In the control unit 800, the X- and Y-coordinates of the stage 20 and the obstacle may be used to re-establish a driving path P′, allowing the transfer robot 10 to bypass the obstacle O located on the driving direction. In one example, the obstacle sensing information I1 includes X- and Y-coordinates of at least two locations on at least one obstacle O to define a width and location of the at least one obstacle O. Accordingly, the control unit 800 then directs the transfer robot to steer clear of either one of two sides of the at least one obstacle O. In a further example, the control unit 800 determines a driving path P′ based upon the width and locations of one or more obstacles O and a maximum width of the transfer robot, wherein the width is orthogonal to the driving path P′. The driving unit 900 may be controlled by the control unit 800 to move the robot main body 100-800 toward the stage 20 along the re-established driving path P′. Accordingly, the transfer robot 10 can move toward the stage 20 (in step S14 of FIG. 4), without colliding with the obstacle O (e.g., along the re-established driving path P′).

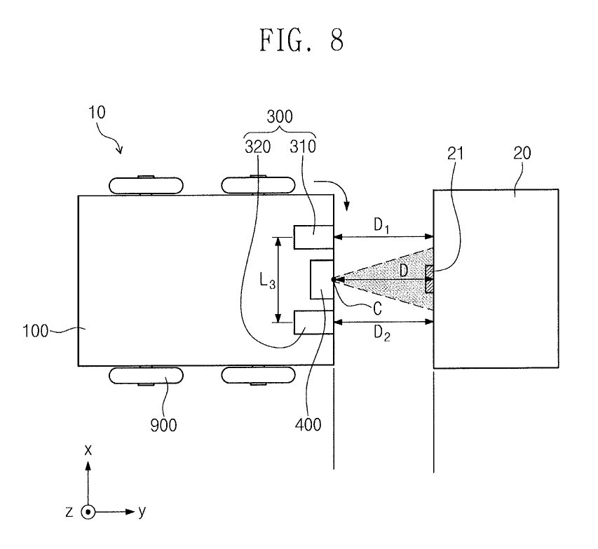

FIG. 7 and FIG. 8 are plan views illustrating a positioning of a robot main body relative to a stage, based on distance information and first image information that are obtained by the distance sensor unit and the first image acquisition unit, respectively of FIG. 1. To reduce complexity in the drawings and to provide better understanding of the inventive concept, some elements of the transfer robot of FIG. 1 may be omitted from FIG. 7 and FIG. 8. For concise description, an element previously described with reference to FIG. 1, FIG. 2 and FIG. 3 may be identified by a similar or identical reference number without repeating an overlapping description thereof.

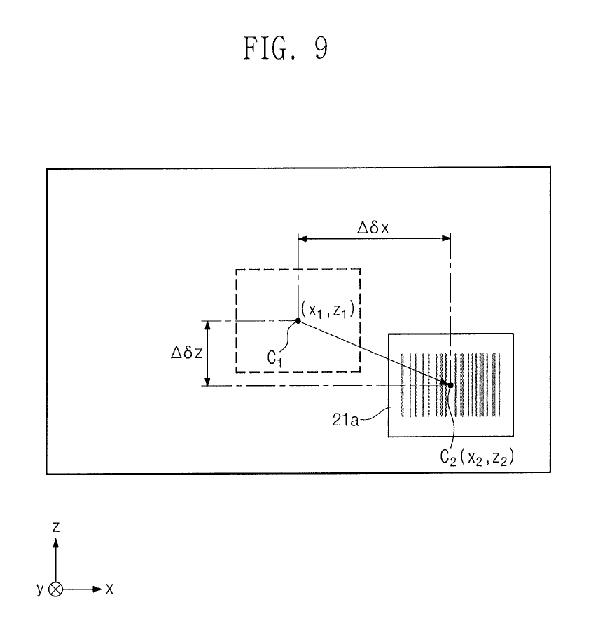

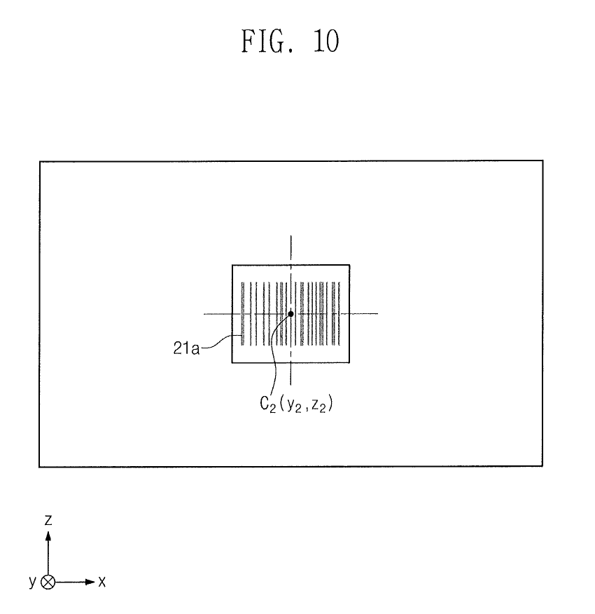

Referring to FIG. 1 to FIG. 8, as a result of the movement of the robot main body 100-800 along the driving path P or P′, the robot main body 100-800 may be positioned at the target position “C” adjacent to the stage 20. In one embodiment, a center of the image sensor on the first image acquisition unit 400 will coincide with the coordinates for the target position C. However, there may be an error between a rest position of the robot main body 100-800 and the target position C as shown in FIG. 7. For example, there may be an error between the rest position of the robot main body 100-800 and a teaching position (not shown), which is appropriate to pick up the target object 30 (e.g., see FIG. 10 and FIG. 14) using the manipulation unit 600 of the transfer robot 10. In this case, based on the distance information I2 and the first image information I3, the control unit 800 may control the driving unit 900 to reduce an error between the rest position of the robot main body 100-800 and the target position C. Here, the target position C may be selected to allow a relative distance “D” between the body unit 100 and the stage 20 to be substantially equal to a predetermined distance and moreover to allow a reference point “C₂” (e.g., see FIG. 9 and FIG. 10) of the first mark 21 to coincide with at least a portion of a predetermined reference coordinate “C₁” (e.g., see FIG. 9 and FIG. 10).

As a result of the movement along the driving path P, the body unit 100 may be spaced apart from the stage 20 by a predetermined relative distance D. In addition, the body unit 100 may be placed to form a predetermined relative angle “α” with respect to the stage 20. Here, the relative distance D may refer to a straight distance from a center point of a surface of the body unit 100 (e.g., the first image acquisition unit 400) to a surface of the stage 20 provided with the first mark 21. The relative angle α may refer to an angle between the surface of the body unit 100 and the surface of the stage 20 provided with the first mark 21.

The distance sensor unit 300 may obtain information on a distance between the robot main body 100-800 and a stage 20 (e.g., the distance information I2) (in step S15 of FIG. 4). For example, when the body unit 100 is positioned to have the relative angle α (e.g., α≠0) with respect to the stage 20, a first distance D₁ obtained by the first distance sensor 310 may be different from a second distance D₂ obtained by the second distance sensor 320. Here, the first distance D₁ may refer to a straight distance from a portion (e.g., the first distance sensor 310) of the body unit 100 to the stage 20. The second distance D₂ may refer to a straight distance from another portion (e.g., the second distance sensor 320) of the body unit 100 to the stage 20.

When the body unit 100 is positioned adjacent to the stage 20, the control unit 800 may obtain the relative angle α between the body unit 100 and the stage 20 and the relative distance D between the body unit 100 and the stage 20 from information on the first distance D₁, the second distance D₂, and distance “L3” (see FIG. 7) between the first and second distance sensors 310 and 320 respectively (in step S16 of FIG. 4). Here, the distance L3 may refer to a distance from a centerline (not shown) of the first distance sensor 310 to a center line (not shown) of the second distance sensor 320. In one example, the distance L3 is measured between the centroid of a sensor in each of the respective distance sensors 310 and 320.

The control unit 800 may calculate the relative distance D, using the following equation 1:

D=(D₁+D₂)/2 Equation 1:

The control unit 800 may calculate the relative angle α, using the following equation 2:

α=tan⁻¹((D₁-D₂)/L)) Equation 2:

With reference to FIG. 8, the control unit 800 may control the driving unit 900 until the relative angle α is equal to a predetermined angle value (in step S18 of FIG. 4). In certain embodiments, the control unit 800 may control the driving unit 900 until the relative angle α is less than the predetermined angle value. In some embodiments, the predetermined angle value may be about 0 degrees, but the inventive concept may not be limited thereto. If the relative angle α is about 0 degrees, the body unit 100 may be positioned in such a way that a surface thereof is substantially parallel to a surface of the stage 20. In some embodiments, the predetermined angle is defined with tolerances limited in part by the accuracy of the distance sensors 310 and 320.

In certain embodiments, the control unit 800 may control the driving unit 900 to allow a difference between the first and second distances D₁ and D₂ respectively to be equal to or less than a predetermined value. For example, the control unit 800 may control the driving unit 900 until the difference between the first and second distances D₁ and D₂ is zero (as defined by the measurement resolution of the distance sensors 310 and 320). In this case, the body unit 100 may be positioned in such a way that its surface is parallel to a surface of the stage 20. The control unit 800 may control the driving unit 900 to allow the relative distance D between the body unit 100 and the stage 20 to be within a predetermined distance range.

FIG. 9 is a schematic view of an example of the first image information obtained by the first image acquisition unit with the transfer robot 10 positioned as shown in FIG. 7. FIG. 10 is a schematic view of an example of the first image information obtained by the first image acquisition unit with the transfer robot 10 positioned as shown in FIG. 8. A region depicted by a dotted line of FIG. 9 shows an image of the first mark 21 (e.g., in the first image information I3), which is obtained when the robot main body 100-800 is positioned at a desired position that is appropriately spaced apart from the stage 20.

Referring to FIG. 1 to FIG. 10, the first image acquisition unit 400 may be configured to take images of the first mark 21 of the stage 20 and obtain the first image information I3, in which the images of the first mark 21 are contained (in step S15 of FIG. 4). The control unit 800 may receive the first image information I3 obtained by the first image acquisition unit 400. The control unit 800 may obtain position information on a reference point C₂ of the first mark 21, based on the first image information I3 (in step S17 of FIG. 4). For example, the control unit 800 may obtain X- and Z-coordinates (x₂, z₂) of the reference point C₂ of the first mark 21, based on the first image information I3. In some embodiments, the reference point C₂ of the first mark 21 may be a center point of the first mark 21, but the inventive concept may not be limited thereto. For example, any point of the first mark 21, other than the center point may be selected as the reference point C₂ of the first mark 21.

The control unit 800 may control the driving unit 900 until at least one of the X- and Z-coordinates (x₂, z₂) corresponding to C₂ coincides with the predetermined reference coordinate C₁ (in step S19 of FIG. 4). Here, the reference coordinate C₁ may represent coordinates (x₂, z₂) of the reference point C₂ of the first mark 21, which are contained in the first image information I3 when the robot main body 100-800 is located at the target position C that is appropriately spaced apart from the stage 20, and the reference coordinate C₁ may include X- and Z-coordinates (x₁, z₁). In some embodiments, the predetermined reference coordinate C₁ may be input via a user interface by a user.

When the robot main body 100-800 is located adjacent to the stage 20, the body unit 100 may be positioned in such a way that the relative distance D is equal to a predetermined distance. Here, the obtained coordinates of the reference point C₂ of the first mark 21 may not coincide with the predetermined reference coordinate C₁.

The control unit 800 may calculate an error Δδx between the X-coordinate x₂ of the reference point C₂ of the first mark 21 and the X-coordinate x₁ of the predetermined reference coordinate C₁. The control unit 800 may calculate an error Δδz between the obtained Z-coordinate z₂ of the reference point C₂ of the first mark 21 and the Z-coordinate z₁ of the predetermined reference coordinate C₁.

The control unit 800 may control the driving unit 900 to move the robot main body 100-800 by the calculated errors Δδx and Δδz in the X- and Z-directions to minimize the errors Δδx and Δδz during a subsequent calculation. Accordingly, the robot main body 100-800 may be located at the target position C that is appropriately spaced apart from the stage 20.

In some embodiments, the control unit 800 may control the driving unit 900 to allow the X- and Z-coordinates (x₂, z₂) obtained from the first image information I3 to coincide with the X- and Z-coordinates (x₁, z₁) contained in the predetermined reference coordinate C₁. In certain embodiments, the control unit 800 may control the driving unit 900 to allow only the X-coordinate x₂ to coincide with the X-coordinate x₁ contained in the predetermined reference coordinate C₁.

When the relative distance D between the body unit 100 and the stage 20 coincides with the predetermined distance and the X- and Z-coordinates (x₂, z₂) obtained from the first image information I3 coincide with the X- and Z-coordinates (x₁, z₁) contained in the predetermined reference coordinate, the robot main body 100-800 may be positioned at the target position C (e.g., see FIG. 7 and FIG. 8).

Referring to FIG. 8, when a relative angle between the body unit 100 and the stage 20 is equal to or less than the predetermined angle value, the body unit 100 may be positioned in such a way that a surface thereof is substantially parallel to a surface of the stage 20. That is, when the robot main body 100-800 is positioned at the target position C and a surface of the body unit 100 is parallel to that of the stage 20, the robot main body 100-800 may be located at a desired position that is appropriately spaced apart from the stage 20.

Information code 21a may be formed on the first mark 21 of the stage 20. For example, the information code 21a of the first mark 21 may include a QR code, a barcode, or a DATA matrix. The control unit 800 may obtain the information code 21a of the first mark 21 from the first image information I3.

The information code 21a of the first mark 21 may include one or more of a position of the stage 20, a relative distance between the robot main body 100-800 and the stage 20, a relative angle between the robot main body 100-800 and the stage 20, and a reference coordinate of the first mark 21.

The control unit 800 may obtain the information on the position of the stage 20, on the relative distance between the robot main body 100-800 and the stage 20, on the relative angle between the robot main body 100-800 and the stage 20, and on the reference coordinate of the first mark 21 from the information code 21a.

When a plurality of stages 20 are provided (as shown in FIG. 5 and FIG. 6), the relative distance D and angle α between each of the stages 20 and the robot main body 100-800 and the reference coordinate (x₁, z₁) may be dependent on a position of each of the stages 20. In the control unit 800, the obtained relative distance information may be used as the predetermined distance. In the control unit 800, the obtained relative angle information may be used as the predetermined angle value. In the control unit 800, the obtained reference coordinate information may be used as the reference coordinate. Accordingly, for each of the stages 20, the robot main body 100-800 may be located at a desired position that is appropriately spaced apart from each of the stages 20.

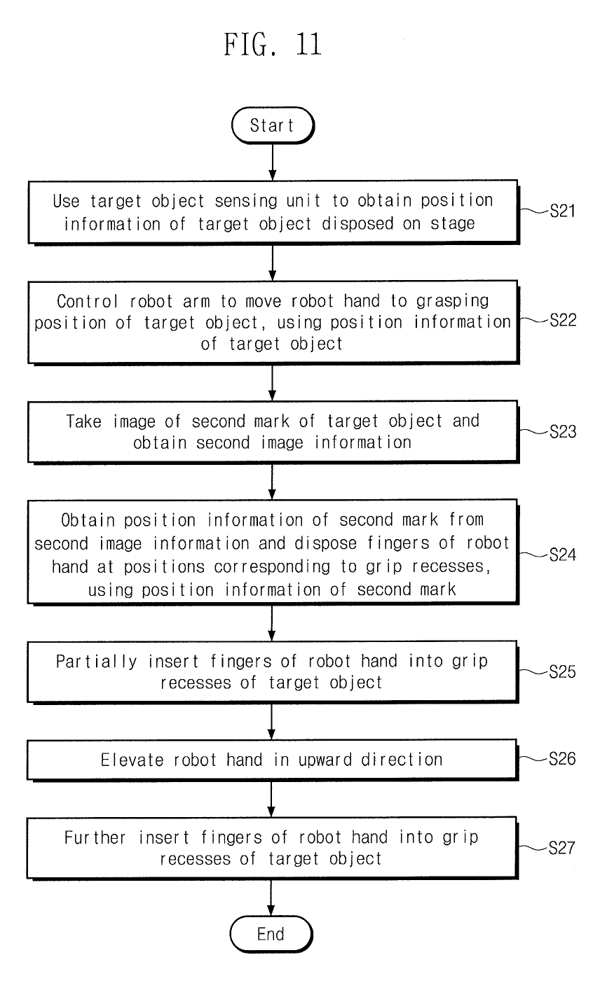

FIG. 11 is a flow chart of a process for grasping and picking up a target object using the transfer robot of FIG. 1. FIG. 12 and FIG. 13 are diagrams schematically illustrating a process for scanning a target object using the target object-sensing unit 500 of FIG. 1. To reduce complexity in the drawings and to provide better understanding of the inventive concept, some elements of the transfer robot of FIG. 1 may be omitted from FIG. 12 and FIG. 13. For concise description, an element previously described with reference to FIG. 1, FIG. 2 and FIG. 3 may be identified by a similar or identical reference number without repeating an overlapping description thereof.

Referring to FIG. 1 to FIG. 3, and FIG. 11 to FIG. 13, the target object-sensing unit 500 may include the detection sensor 510 and the scan unit 520. In some embodiments, the scan unit 520 may be configured to rotate the detection sensor 510 on an X-Y plane by a specific angle range. This may allow the target object-sensing unit 500 to obtain the target object position information I4 on a position of the target object 30 in the scan region S (in step S21 of FIG. 11). Here, the target object position information I4 may include X- and Y-coordinates of the target object 30.

The scan unit 520 may be configured to adjust or change a position of the detection sensor 510 in a Z-direction. Accordingly, the target object-sensing unit 500 may obtain information on a Z-coordinate of the target object 30 in the scan region S (e.g., a two dimensional scan region). The information on X, Y, and Z-coordinates of the target object 30 obtained by the target object-sensing unit 500 may be transmitted to the control unit 800.

Based on the target object position information I4 obtained by the target object-sensing unit 500, the control unit 800 may control the robot arm 610 to move the robot hand 620 toward the target object 30 (in step S22 of FIG. 11). For example, the control unit 800 may calculate a grasping position allowing the robot hand 620 to grasp the target object 30, based on the information on the X, Y, and Z-coordinates of the target object 30 obtained by the target object-sensing unit 500. The robot arm 610 may be controlled to move the robot hand 620 to the calculated grasping position. The calculated grasping position may be expressed in terms of X, Y, and Z-coordinates.

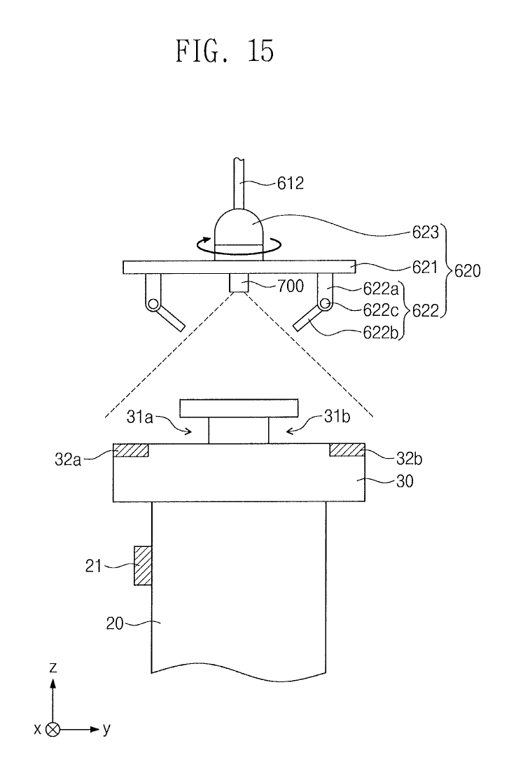

FIG. 14 and FIG. 15 are diagrams schematically illustrating a process for controlling positions of fingers of a robot hand relative to respective grip recesses of a target object, using second image information obtained by the second image acquisition unit of FIG. 1. For concise description, an element previously described with reference to FIG. 1, FIG. 2 and FIG. 3 may be identified by a similar or identical reference number without repeating an overlapping description thereof.

Referring to FIG. 3, FIG. 11, FIG. 14, and FIG. 15, the target object 30 may include the grip recesses 31a and 31b, in which the fingers 622 of the robot hand 620 are respectively inserted. In some embodiments, the target object 30 may include a pair of the grip recesses 31a and 31b. Accordingly, the robot hand 620 may be configured to have two fingers 622. The target object 30 may include at least one second mark. In some embodiments, the target object 30 may include a pair of the second marks 32a and 32b. Each of the second marks 32a and 32b may be provided to correspond to, or be adjacent to, the grip recesses 31a and 31b, respectively. The second marks 32a and 32b of the target object 30 may be provided to display information code (not shown). For example, the second marks 32a and 32b may be provided in the form of QR code, barcode, or DATA matrix) to display the information code.

The second image acquisition unit 700 provided on the palm 621 of the robot hand 620 may be configured to take images of the second marks 32a and 32b of the target object 30 and to obtain the second image information I5, in which the images of the second marks 32a and 32b are contained (in step S23 of FIG. 11). For example, when the robot hand 620 is placed at the grasping position of the target object 30 and before the fingers 622 of the robot hand 620 are inserted into the grip recesses 31a and 31b, the second image acquisition unit 700 may take images of the second marks 32a and 32b of the target object 30 and may obtain the second image information I5.

The control unit 800 may obtain information on positions of the second marks 32a and 32b, based on the second image information I5 (in step S24 of FIG. 11). The position information of the second marks 32a and 32b may include X- and Y-coordinates of each of the second marks 32a and 32b. The control unit 800 may extract the X- and Y-coordinates of the second marks 32a and 32b from the position information of the second marks 32a and 32b. In the control unit 800, the extracted X- and Y-coordinates of the second marks 32a and 32b may be used to place the fingers 622 of the robot hand 620 at the X- and Y-coordinates of respective ones of the second marks 32a and 32b (in step S24 of FIG. 11). Thus, each of the fingers 622 is placed at an appropriate position for a corresponding one of the grip recesses 31a and 31b.

The control unit 800 may extract an information code (not shown) of the second marks 32a and 32b from the second image information I5. The information code of the second marks 32a and 32b may contain information on the target object 30. For example, the information code of the second marks 32a and 32b may contain various types of information (e.g., a kind or a production year of the target object 30). The control unit 800 may transmit the information on the target object 30 to a user via a communication unit (not shown).

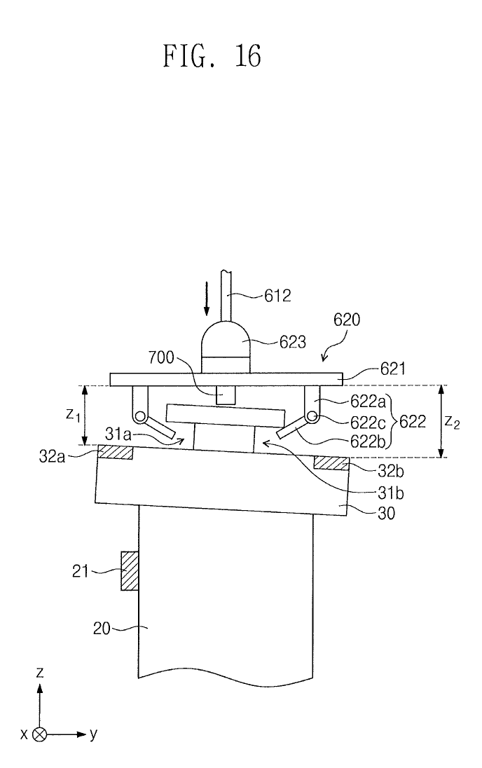

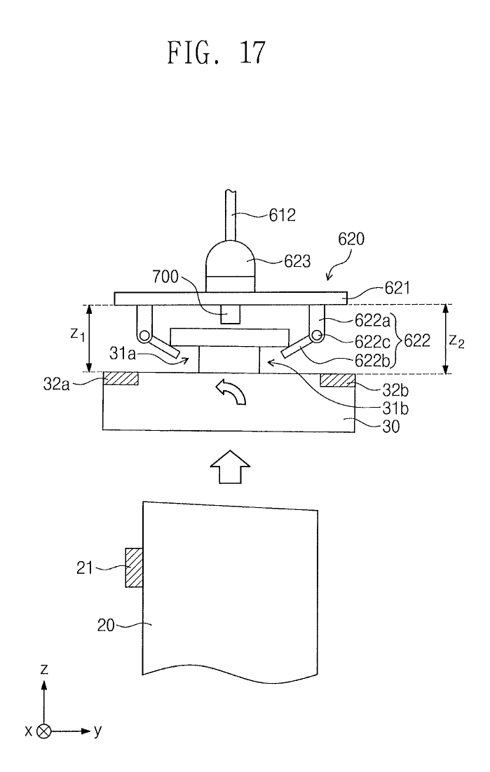

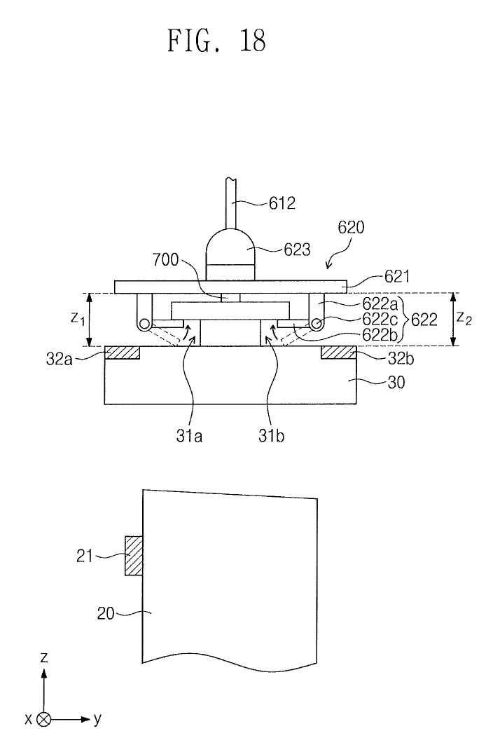

FIG. 16, FIG. 17 and FIG. 18 are diagrams schematically illustrating a process for grasping and picking up a target object using the robot hand of FIG. 1. For concise description, an element previously described with reference to FIG. 1, FIG. 2 and FIG. 3 may be identified by a similar or identical reference number without repeating an overlapping description thereof.

Referring to FIG. 3, FIG. 11, FIG. 16, FIG. 17 and FIG. 18, if each of the fingers 622 is placed at an appropriate position for a corresponding one of the grip recesses 31a and 31b, the robot hand 620 may be lowered in a Z-direction by the robot arm 610. In other words, the robot hand 620 may be moved to have the same Z-coordinate as the grasping position of the target object 30.

Thereafter, under the control of the control unit 800, the fingers 622 of the robot hand 620 may be partially inserted into the grip recesses 31a and 31b, respectively (in step S25 of FIG. 11). For example, the control unit 800 may control the robot hand 620 to insert an end portion of the second phalanx 622b of each of the fingers 622 into a corresponding one of the grip recesses 31a and 31b.

If the fingers 622 are partially inserted into the grip recesses 31a and 31b, the control unit 800 may control the robot arm 610 to elevate the robot hand 620 in the Z-direction (in step S26 of FIG. 11). Accordingly, the target object 30 may be separated from the stage 20. Furthermore, the target object 30 may be aligned to be parallel to the palm 621 by gravitational force.

In certain cases, the target object 30 may be placed at an angle to the stage 20. Consequently, the target object 30 will also be placed at an angle to the palm 621 of the robot hand 620. Accordingly, a distance Z₁ between a side portion of the target object 30 and the palm 621 may be different from a distance Z₂ between an opposite side portion of the target object 30 and the palm 621, (see FIG. 16). In other words, there may be a difference in level between the side portions of the target object 30. Here, the level difference may refer to a difference between the distance Z₁ and the distance Z₂.

If the robot hand 620, in which the fingers 622 are partially inserted into the grip recesses 31a and 31b, is elevated in the Z-direction, the target object 30 may be rotated by gravitational force and thus will become aligned to be parallel to the palm 621. Accordingly, it is possible to compensate the difference in level between the side portions of the target object 30.

The control unit 800 may control the robot hand 620 to further insert the fingers 622 into remaining regions of the grip recesses 31a and 31b, respectively, after the elevation of the robot hand 620 (in step S27 of FIG. 11). For example, the control unit 800 may control the robot hand 620 to allow the greater part of the second phalanx 622b of each of the fingers 622 to be inserted into the grip recesses 31a and 31b. This may make it possible to allow the robot hand 620 to more tightly grasp the target object 30.

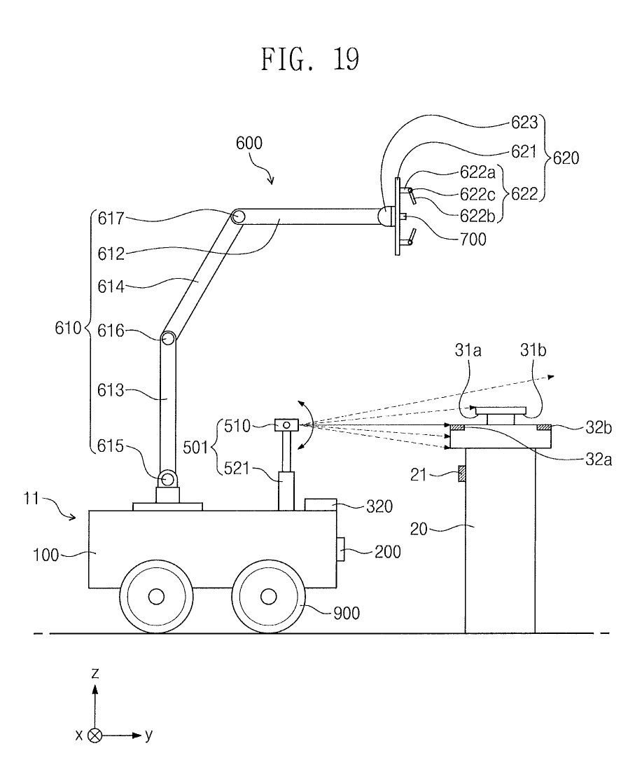

FIG. 19 is diagrams schematically illustrating a process for scanning a target object using a target object-sensing unit of a transfer robot according to some embodiments of the inventive concept. Referring to FIG. 19, an embodiment of a transfer robot 11 may include a robot main body 100-800 and a driving unit 900. The robot main body 100-800 may include a body unit 100, an obstacle-sensing unit 200, a distance sensor unit 300 (which includes a first distance sensor 310, not shown and a second distance sensor 320), a first image acquisition unit 400 (not shown), an embodiment of a target object-sensing unit 501, a manipulation unit 600, a second image acquisition unit 700, and a control unit 800 (not shown). For concise description, an element previously described with reference to FIG. 1 to FIG. 3, FIG. 12, and FIG. 13 may be identified by a similar or identical reference number without repeating an overlapping description thereof.

The target object-sensing unit 501 may include the detection sensor 510 and a scan unit 521. In some embodiments, the scan unit 521 may be configured to rotate the detection sensor 510 on an X-Y plane by a specific angle range. This may allow the target object-sensing unit 500 to obtain information on X- and Y-coordinates of the target object 30 in the scan region S (e.g., see FIG. 12). The scan unit 521 may also be configured to rotate the detection sensor 510 on a Y-Z plane by a specific angle range. This may make it possible for the target object-sensing unit 500 to obtain information on a Z-coordinate of the target object 30 located in the scan region S. In another embodiment, the scan unit 521 is configured to rotate the detection sensor 510 in both the X-Y and the Y-Z planes to form a two dimensional scan region S.

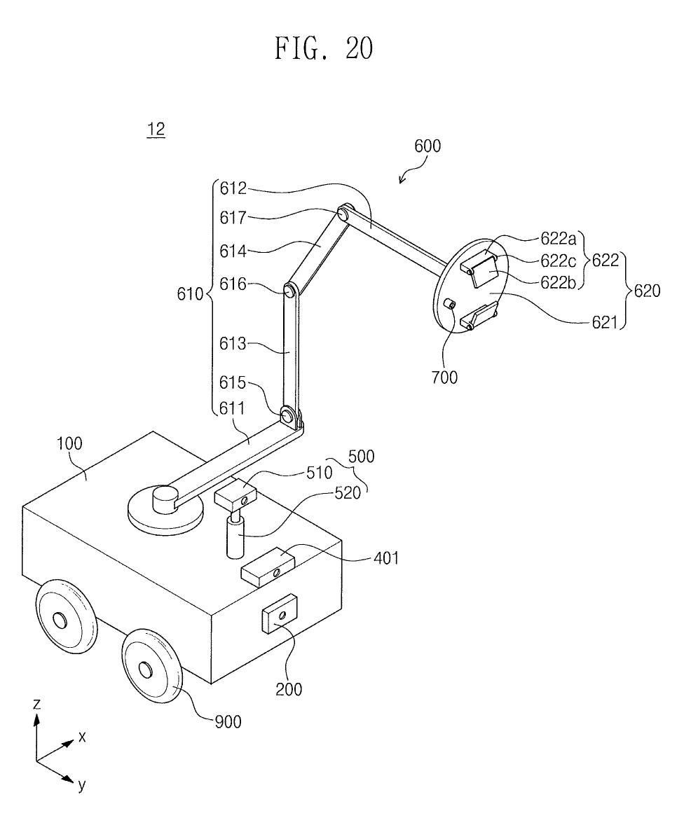

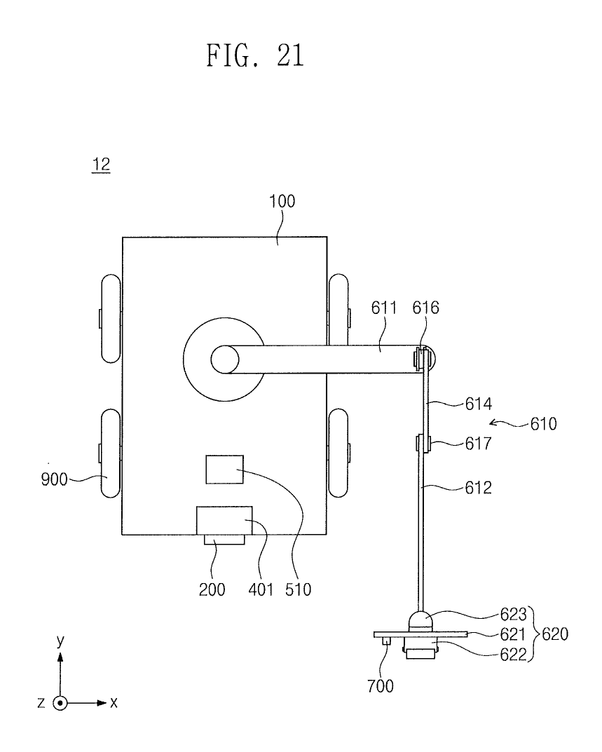

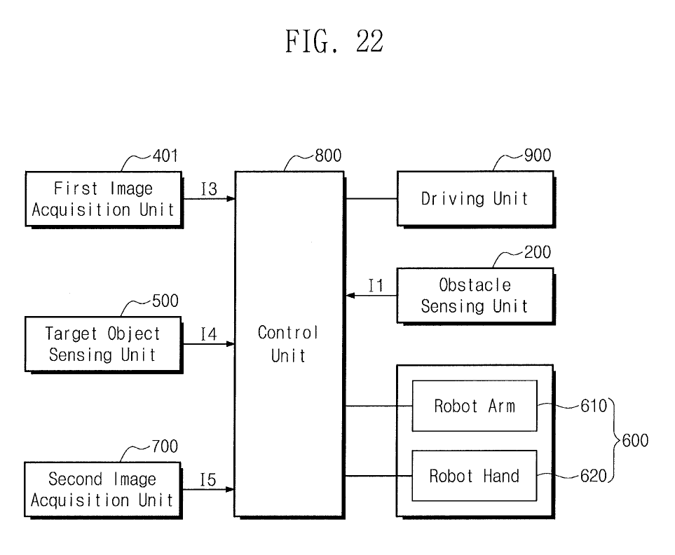

FIG. 20 is a perspective view illustrating a transfer robot according to some embodiments of the inventive concept. FIG. 21 is a plan view illustrating the transfer robot of FIG. 20. FIG. 22 is a block diagram of an example embodiment of the transfer robot of FIG. 20. Referring to FIG. 20 to FIG. 22, a transfer robot 12 according to some embodiments of the inventive concept may include a robot main body 100-800 and a driving unit 900. The robot main body 100-800 may include a body unit 100, an obstacle-sensing unit 200, a first image acquisition unit 401, a target object-sensing unit 500, a manipulation unit 600, a second image acquisition unit 700, and a control unit 800. For concise description, an element previously described with reference to FIG. 1 to FIG. 6 and FIG. 12 to FIG. 18 may be identified by a similar or identical reference number without repeating an overlapping description thereof.

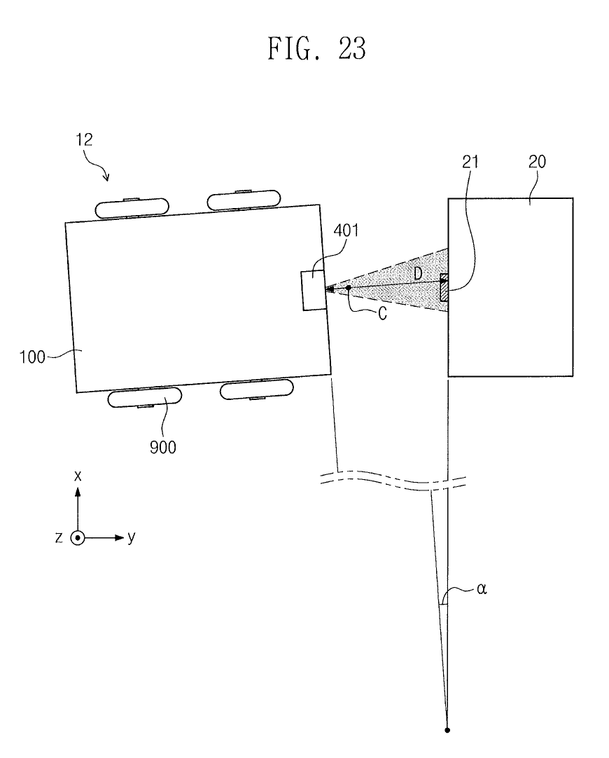

The stage 20 may include a first mark 21 (e.g., see FIG. 23) having a three-dimensional structure. The first mark 21 of the three-dimensional structure may be disposed on a surface of the stage 20. In some embodiments, the first mark 21 may be shaped like a rectangular parallelepiped, but the inventive concept is not limited thereto.

The first image acquisition unit 401 may be configured to obtain the first image information I3, in which three-dimensional images of the first mark 21 of the stage 20 are contained. The first image acquisition unit 401 may also be configured to transmit the first image information I3 to the control unit 800. The first image information I3 may include at least one two-dimensional or three-dimensional image of the first mark 21.

The control unit 800 may receive the first image information I3 obtained by the first image acquisition unit 401. In the control unit 800, the first image information I3 may be used to control the driving unit 900 to allow the robot main body 100-800 to be located at a desired position that is appropriately spaced apart from the stage 20. This will be described in more detail with reference to FIG. 23 to FIG. 26. The target object-sensing unit 500 may be configured to detect a target object (not shown) disposed on the stage 20. The target object-sensing unit 500 may include the detection sensor 510 and the scan unit 520.

The manipulation unit 600 may be provided on the body unit 100 and may be used to grasp and pick up a target object (not shown) disposed on the stage 20. The manipulation unit 600 may include the robot hand 620, which is configured to grasp the target object (not shown), and the robot arm 610, which is used to change a position of the robot hand 620.

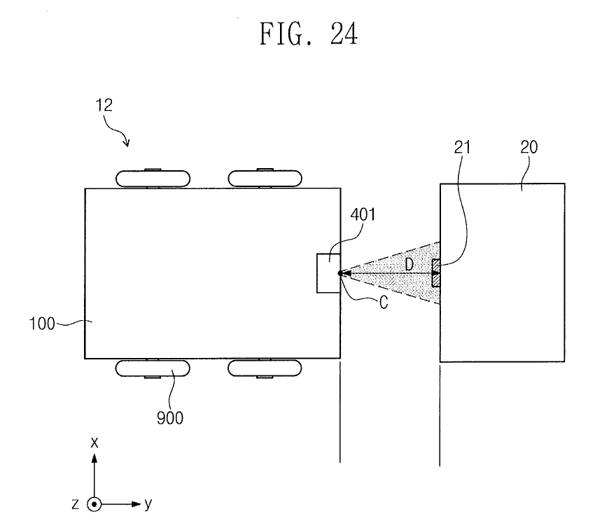

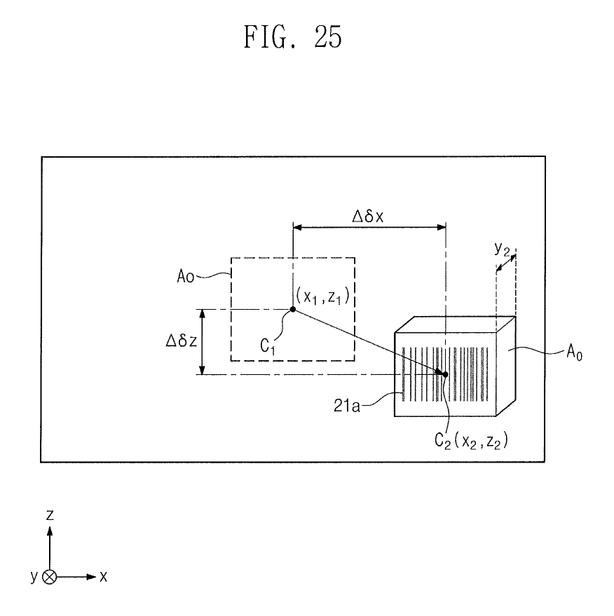

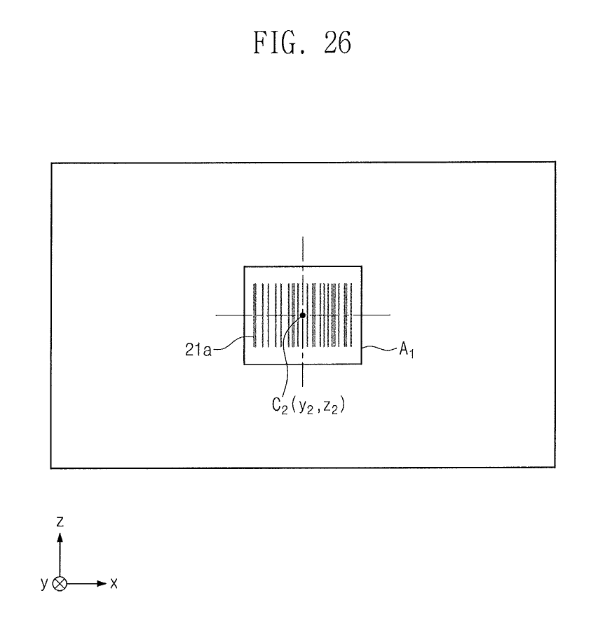

FIG. 23 and FIG. 24 are plan views of a process for controlling a position of a robot main body relative to a stage using first image information obtained by the first image acquisition unit 401 of FIG. 20. FIG. 25 is a schematic view of an example of the first image information obtained by the first image acquisition unit with the transfer robot 12 positioned as shown in FIG. 23. FIG. 26 is a diagram illustrating an example of the first image information obtained by the first image acquisition unit with the transfer robot 12 positioned as shown in FIG. 24. For concise description, an element previously described with reference to FIG. 1 to FIG. 3 and FIG. 9 to FIG. 18 may be identified by a similar or identical reference number without repeating an overlapping description thereof.

Referring to FIG. 23 to FIG. 26, the driving unit 900 may be controlled by the control unit 800 (e.g., see FIG. 22) to move the robot main body 100-800 toward the target position C adjacent to the stage 20 along a driving path (not shown), Accordingly, the robot main body 100-800 may be placed at a position adjacent to the stage 20. There may be an error between a rest position of the robot main body 100-800 and the target position. For example, there may be an error between the rest position of the robot main body 100-800 and a teaching position, which is appropriate to pick up the target object (not shown) using the manipulation unit 600 of the transfer robot 12.

As a result of the movement along the driving path, the robot main body 100-800 may be spaced apart from a surface of the stage 20 by a predetermined relative distance D. The robot main body 100-800 may be placed to form a predetermined relative angle α with respect to the stage 20. Here, the relative distance D may refer to a straight distance from a center point of a surface of the body unit 100 of the robot main body 100-800 to the stage 20. For example, the distance D may be measured from a centroid of the first image acquisition unit 401 to the stage 20. The relative angle α may refer to an angle between a surface of the body unit 100 of the robot main body 100-800 and the surface of the stage 20 provided with the first mark 21.

The control unit 800 may obtain a projection area A₁ (see FIG. 26) of the first mark 21 on the X-Z plane, based on the first image information I3. In the control unit 800, the obtained projection area A₁ of the first mark 21 on the X-Z plane may be used as a reference area A₀ for calculating the relative distance D between the body unit 100 and the stage 20. For example, the shorter a distance from the body unit 100 to the stage 20, the larger the obtained projection area A₁ of the first mark 21 on the X-Z plane. Conversely, the longer the distance from the body unit 100 to the stage 20, the smaller the obtained projection area A₁ of the first mark 21 on the X-Z plane. Accordingly, the control unit 800 may calculate the relative distance D between the body unit 100 and the stage 20, based on a perspective principle. The control unit 800 may control the driving unit 900 to allow the obtained projection area A₁ of the first mark 21 on the X-Z plane to be the same as the reference area A₀.

The control unit 800 may obtain a length y₂ in Y-direction of the first mark 21, based on the first image information I3. When the body unit 100 is placed to form the relative angle α with respect to the stage 20 (as shown in FIG. 23), the first image information I3 may contain a three-dimensional image of the first mark 21.

The control unit 800 may obtain a length y₂ in the Y-direction of the first mark 21, based on the three-dimensional image of the first mark 21. The control unit 800 may also obtain the relative angle α between the body unit 100 and the stage 20 from the obtained length yz. For example, the larger the relative angle α between the body unit 100 and the stage 20, the longer the obtained length y₂ in Y-direction of the first mark 21. Conversely, the lower the relative angle α between the body unit 100 and the stage 20, the shorter the obtained length yz in Y-direction of the first mark 21.

The control unit 800 may control the driving unit 900 until the relative angle α is equal to a predetermined angle value. In certain embodiments, the control unit 800 may control the driving unit 900 until the relative angle α is less than the predetermined angle value. In some embodiments, the predetermined angle value may be about 0 degrees, but the inventive concept may not be limited thereto. If the relative angle α is about 0 degrees, the body unit 100 may be placed in such a way that a surface thereof is substantially parallel to a surface of the stage 20. If the body unit 100 is placed to have a surface parallel to a surface of the stage 20, the length in Y-direction of the first mark 21 obtained by the control unit 800 may be substantially zero.

The control unit 800 may obtain position information on the reference point C₂ of the first mark 21, based on the first image information I3. For example, the control unit 800 may be configured to calculate X- and Z-coordinates (x₂, z₂) of the reference point C₂ of the first mark 21, based on the first image information I3. In some embodiments, the reference point C₂ of the first mark 21 may be a center point of the first mark 21, but the inventive concept is not limited thereto.

The control unit 800 may control the driving unit 900 until at least one of the X- and Z-coordinates (x₂, z₂) coincides with the predetermined reference coordinate C₁. Here, the reference coordinate C₁ may represent coordinates of the reference point C₂ of the first mark 21, which are contained in the first image information I3 when the robot main body 100-800 is located at a desired position that is appropriately spaced apart from the stage 20, and the reference coordinate C₁ may include X- and Z-coordinates (x₁, z₁).

When the robot main body 100-800 is located to be adjacent to the stage 20, the obtained the reference point C₂ of the first mark 21 may not coincide with the predetermined reference coordinate C₁. The control unit 800 may calculate an error Mx between the X-coordinate x₂ of the reference point C₂ of the first mark 21, which is obtained from the first image information I3, and the X-coordinate x₁ contained in the predetermined reference coordinate C₁. The control unit 800 may calculate an error 46z between the Z-coordinate z₂ of the reference point C₂ of the first mark 21, which is obtained from the first image information I3, and the Z-coordinate z₁ of the predetermined reference coordinate C₁.

Referring to FIG. 22 and FIG. 24, the control unit 800 may control the driving unit 900 to move the robot main body 100-800 by the calculated errors Δδx and Δδz in the X- and Z-directions, to minimize the errors Δδx and Δδz during a subsequent calculation. Accordingly, the robot main body 100-800 may be located at a desired position that is properly spaced apart from the stage 20. In other words, in some embodiments, the control unit 800 may control the driving unit 900 until the X- and Z-coordinates (x₂, z₂) coincide with the X- and Z-coordinates (x₁, z₁) of the predetermined reference coordinate C₁. In certain embodiments, the control unit 800 may control the driving unit 900 until one of the X- and Z-coordinates (x₂, z₂) coincides with that of the predetermined reference coordinate C₁. According to some embodiments of the inventive concept, a transfer robot may be configured to move to a desired position in an autonomous manner and to grasp and pick up a target object.

While example embodiments of the inventive concepts have been particularly shown and described, it will be understood by one of ordinary skill in the art that variations in form and detail may be made therein without departing from the spirit and scope of the attached claims.

What is claimed is:

1. A transfer robot, comprising:
a robot main body; and
a driving unit configured to move the robot main body toward a stage,
wherein the robot main body comprises:
a distance sensor unit configured to obtain distance information between the robot main body and the stage, and
a first image acquisition unit configured to take an image of a first mark of the stage and to obtain a first image information;
a manipulation unit configured to pick up a target object disposed on the stage; and
a control unit configured to control the driving unit using the distance information and the first image information, thereby causing the robot main body to be placed at a desired position spaced apart from the stage.

2. The transfer robot of claim 1, wherein the distance sensor unit comprises:
a first distance sensor; and
a second distance sensor having spatial separation from the first distance sensor.

3. The transfer robot of claim 2, wherein the control unit is configured to determine a relative angle between the robot main body and the stage based on a distance between the first and second distance sensors, a first distance and a second distance, which are respectively obtained by the first and second distance sensors, and to control the driving unit to cause the relative angle to be equal to or smaller than a predetermined angle value.

4. The transfer robot of claim 2, wherein the control unit is configured to control the driving unit to cause a difference between a first distance and a second distance, which are respectively obtained by the first and second distance sensors, to be equal to or smaller than a predetermined value.

5. The transfer robot of claim 2, wherein the first image acquisition unit is disposed equidistantly between the first and second distance sensors.

6. The transfer robot of claim 1, wherein the control unit is configured to obtain an X-coordinate and a Z-coordinate of a reference point of the first mark from the first image information and to control the driving unit to allow at least one of the X-coordinate and the Z-coordinate to coincide with a predetermined one of the reference coordinates.

7. The transfer robot of claim 6, wherein the reference point of the first mark is a center point of the first mark.

8. The transfer robot of claim 1, wherein the robot main body further comprises a target object-sensing unit, configured to detect the target object disposed in a scan region and to obtain an X-coordinate, a Y-coordinate and a Z-coordinate of the target object.

9. The transfer robot of claim 8, wherein the target object-sensing unit comprises:
a detection sensor; and
a scan unit configured to move the detection sensor to scan the scan region.

10. The transfer robot of claim 8, wherein the manipulation unit comprises:
a robot hand configured to grasp the target object; and
a robot arm connected to the robot hand, and configured to change a position of the robot hand,
wherein the control unit is configured to calculate a grasping position, allowing the robot hand to grasp the target object, and to control the robot arm to place the robot hand at the grasping position, and
the X-coordinate, the Y-coordinate and the Z-coordinate of the target object is used to calculate the grasping position.

11. The transfer robot of claim 10, wherein the robot main body further comprises a second image acquisition unit, configured to take an image of a second mark of the target object and to obtain a second image information,
the robot hand comprises fingers configured to be inserted into respective grip recesses of the target object, and
the control unit is configured to obtain a position information of the second mark from the second image information and to control the robot hand, based on the position information of the second mark, to allow each of the fingers to be placed near a position of a corresponding one of the grip recesses.

12. The transfer robot of claim 10, wherein the robot hand comprises fingers configured to be inserted into grip recesses of the target object, and
the control unit is configured to control the robot hand to partially insert the fingers into the grip recesses, to control the robot arm to elevate the robot hand, and to control the robot hand to further insert the fingers into the grip recesses.

13. A method of controlling a transfer robot, comprising:
moving a robot hand to a first position using a robot arm, wherein the robot hand comprises a plurality of fingers configured to grasp a target object having grip recesses;
partially inserting the fingers into the grip recesses with the robot hand at the first position;
elevating the robot hand to a second position higher than the first position, using the robot arm; and
further inserting the fingers into the grip recesses with the robot hand at the second position.

14. The method of claim 13, further comprising detecting the target object and obtaining coordinate information including an X-coordinate, a Y-coordinate, and a Z-coordinate of the target object, using a target object-sensing unit,
wherein the first position is calculated from the X-coordinate, the Y-coordinate and the Z-coordinate of the target object.

15. The method of claim 14, wherein the robot arm and the robot hand are used as parts of a robot main body,
wherein the robot main body further comprises a distance sensor unit and an image acquisition unit, and
wherein the target object is disposed on a stage having spatial separation from a desired position and comprises a first mark,
wherein the method further comprises:
obtaining a distance information between the robot main body and the stage, using the distance sensor;
obtaining a first image information containing an image of the firstmark, using the first image acquisition unit; and
moving the robot main body to the desired position, using the distance information and the first image information.

16. A transfer robot comprising:
a steerable platform having an articulating arm attached thereto;
a controller coupled to the steerable platform, the controller configured to position a first surface of the steerable platform at a predetermined distance, and with parallel alignment, to a second surface of a stage having a target object disposed thereon; and
a robotic hand connected to the articulating arm, the robotic hand including at least two movable phalanxes configured to grip a respective recessed feature of the target object.

17. The transfer robot of claim 16 further comprising a plurality of distance sensors proximally located to the first surface and configured to measure a measured distance between the first surface and the second surface, wherein the controller directs a movement of the steerable platform towards the stage until the measured distance is the same as the predetermined distance.

18. The transfer robot of claim 17 wherein a difference between two of the plurality of distance sensors is reduced by steering the steerable platform, thereby aligning the first surface in parallel to the second surface.

19. The transfer robot of claim 16 further comprising an obstacle sensor proximally located to the first surface, the obstacle sensor configured to detect an object between the steerable platform and the stage, and to communicate to the controller to alter a path between the steerable platform and the stage.

20. The transfer robot of claim 16 further comprising a rotatable connection between the robotic hand and the articulating arm configured to provide rotational alignment between the robotic hand and the target object, an image sensor on the robotic hand configured to receive an image of an alignment mark on the target object, the image communicated to the controller to move the at least two phalanxes to grip the respective recessed feature of the target object.
